(19) United States
(12) Patent Application Publication
(10) Pub. No.: US 2022/0386652 A1
(43) Pub. Date: Dec. 8, 2022

(54) LIQUID FOOD PRODUCT COMPRISING LIQUID FRACTION OF BREWER'S SPENT GRAIN

(71) Applicant: CIRCULAR FOOD TECHNOLOGY APS, Copenhagen K (DK)

(72) Inventors: Karin BEUKEL, III, Copenhagen S (DK); Victor KIRKETERP, Copenhagen N (DK); Hannah KRAUS, Copenhagen SV (DK); Emil BUHL KRØLL, Copenhagen NV (DK); Ophelia PEDERSEN, Frederiksberg (DK); Aviaja Bondo RIEMANN-ANDERSEN, Frederiksberg C (DK); Saskia URLASS, Unma (DE); Ytse DE VRIES, Wergea (NL)

(21) Appl. No.: 17/771,231

(22) PCT Filed: Oct. 26, 2020
(86) PCT No.: PCT/EP2020/080034

§ 371 Date: Apr. 22, 2022

(30) Foreign Application Priority Data
Oct. 25, 2019 (EP) 19205382.5

(51) Int. Cl. A23L 2/02; A23L 2/60; A23L 2/56; A23L 33/105; A23L 33/28; A23L 33/22

(52) U.S. Cl. CPC A23L 2/02; A23L 2/60; A23L 2/56; A23L 33/105; A23L 33/28; A23L 33/22

(57) ABSTRACT

The present invention relates to a liquid food product comprising a liquid fraction of a brewer's spent grain and a method of preparing said liquid food product. In particular the liquid food product is prepared from brewer's spent grain where a vegetable or animal material has been added and the mixture subjected to an extraction step to provide an improved taste and mouthfeel.

### TECHNICAL FIELD OF THE INVENTION

The present invention relates to a liquid food product comprising a liquid fraction of a brewer's spent grain and the method of preparing said liquid food product. In particular, the present invention relates to a beverage comprising a liquid fraction of brewer's spent grain and a flavour improving agent selected from the group of an extract of an ingredient of vegetable material or animal material. The present invention also relates to a method of preparing a liquid food product by extracting one or more flavour improving agents selected from an ingredient of vegetable material or animal material in a liquid fraction of brewer's spent grains.

### BACKGROUND OF THE INVENTION

The focus on avoiding food waste has increased over the past years and therefore the reuse of waste products from the preparation of various food products has increased.

Brewer's spent grain (BSG) is typically a by-product from the brewing industry and whiskey distillation. BSG is currently mainly used as feed for livestock, such as feed for cattle, poultry and pigs. However, an interest for the use of brewer's spent grain in the production of human foods has increased because of the nutritional value of brewer's spent grain.

For example, US 2019/0 200 640 A1 discloses a beverage obtained by enzymatic saccharification and fermentation of brewer's spent grain (BSG) and a process of preparing such beverage, where brewer's spent grain is diluted in distilled water before the enzymatic treatment and fermentation.

EP 3 085 243 A1 discloses a beverage obtained by providing malt and/or unmalted grains, providing mashing liquor from spent grains (the mashing liquor is obtained by crushing spent grains, adding brewing liquor and enzymes to make an enzymatic degradation) and process the malt and mashing liquor to obtain a wort. The wort is fermented by using yeast.

However, brewer's spent grain has an unpleasant taste and mouthfeel even after dilution in water. Further, enzymatic hydrolysis used for fibre solubilisation and saccharification of the BSG is a complex process that is wished avoided. The trend is also that consumers request food products with a more clean label and less added compounds. Addition of enzymes requires labelling. Further, the use of enzymes is a time consuming and expensive process and results in byproduct which requires further processing.

Hence, a beverage or another type of liquid food product comprising BSG that has an improved flavour, but has maintained the nutritional value of BSG would be advantageous. Furthermore, a beverage made without the use of adding enzymes would be advantageous. A beverage made with reduced amount of additives but comprising flavour improving agents of natural occurring origin would also be advantageous.

### SUMMARY OF THE INVENTION

Thus, an object of the present invention relates to providing a liquid food product, such as a beverage, porridge or soup, that have good nutritional value and have an improved and acceptable flavour. In addition, it is an object of the present invention to provide a liquid food product, from brewer's spent grain that has an acceptable flavour, good mouthfeel and good nutritional value without having been subjected to addition of enzymes. Further, it is an object of the present invention to provide a method of preparing said liquid food product.

In particular, it is an object of the present invention to provide a liquid food product comprising brewer's spent grain that solves the above mentioned problems of the prior art.

Thus, one aspect of the invention relates to a liquid food product comprising a liquid fraction of a brewer's spent grain in an amount of from 10% to 100% by weight.

Another aspect of the present invention relates to a method of preparing a liquid food product comprising the steps of:
i) providing a liquid fraction of brewers spent;
ii) optionally adding further ingredients;
iii) subject the liquid fraction of brewer's spent grain to a step of inactivating unwanted microorganisms;
   to obtain the liquid food product.

Still another aspect of the present invention relates to a method of preparing a liquid food product comprising the steps of:
i) providing a liquid fraction of a brewer's spent grain;
   adding one or more flavour improving agent(s) selected from the group of an ingredient of vegetable material or animal material to the fraction of brewer's spent grain to provide a mixture and perform an extraction of the mixture;
ii) optionally adding one or more further ingredients;
iii) subject the extracted mixture of step i) or ii) to a step of inactivating unwanted microorganism in the mixture; and
   hereby obtain the liquid food product.

### BRIEF DESCRIPTION OF THE FIGURES

FIG. 1 shows sensoric evaluation of raw BSG, raw BSG diluted in 50%-wt water, liquid fraction of BSG, a liquid fraction of BSG diluted in 50%-wt water and a boiled liquid fraction of BSG diluted in 50%-wt water.

FIG. 2 shows a spider web of different alcoholic aroma compounds in samples of: boiled liquid fraction of brewer's spent grain (B), unboiled liquid fraction of brewer's spent grain (UB), liquid fraction of brewer's spent grain boiled with blackcurrant leaves (BC).

FIG. 3 shows a spider web of different aldehyde aroma compounds in samples of: boiled liquid fraction of brewer's spent grain (B), unboiled liquid fraction of brewer's spent grain (UB), liquid fraction of brewer's spent grain boiled with blackcurrant leaves (BC).

FIG. 4 shows a spider web of different ketone aroma compounds in samples of: boiled liquid fraction of brewer's spent grain (B), unboiled liquid fraction of brewer's spent grain (UB), liquid fraction of brewer's spent grain boiled with blackcurrant leaves (BC).

FIG. 5 shows a spider web of different aroma compounds selected from acids and others aroma compounds in samples of: boiled liquid fraction of brewer's spent grain (B), unboiled liquid fraction of brewer's spent grain (UB), liquid fraction of brewer's spent grain boiled with blackcurrant leaves (BC).

FIG. 6 shows sensory evaluation of samples of liquid fraction of BSG extracted with blackcurrant leaves as well as samples where juices were added.

FIG. 7 shows GC-MS analysis of the reduction of different chemical compounds in a liquid fraction of BSG extracted with blackcurrant leaves as compared to liquid fraction of BSG but with no extraction with blackcurrent leaves.

FIG. 8 shows shows GC-MS analysis of the increase of different chemical compounds in a liquid fraction of BSG extracted with blackcurrant leaves as compared to liquid fraction of BSG but with no extraction with blackcurrent leaves.

FIG. 9 shows a schematic overview of the process of preparing brewer's spent grain from the beer brewing industry and how the liquid fraction of brewer's spent grain is obtained.

The present invention will now be described in more detail in the following.

### DETAILED DESCRIPTION OF THE INVENTION

Definitions:

Prior to discussing the present invention in further details, the following terms and conventions will first be defined:

The term “liquid food product” means in the context of the present invention a food product being in liquid state and being suitable for human consumption. The term “liquid” is in the context of the present invention to be understood as a product having a moisture content of 40 vol-% or more, in particular 50 vol-% or more. For example, the liquid food product may be selected from the group of a beverage, a liquid breakfast, a porridge, a dessert, a yoghurt, a sauce and a soup. The beverage may for example be a carbonated beverage or non-carbonated beverage. The beverage may for example be selected from the group of smoothie, shake, juice, shot, cocoa drink, cereal milk or ice-tea like drink, but the present invention should not be limited to any of these types of beverages. In an example, the beverage is a ginger shot made of a liquid fraction of brewer's spent grain and ginger. In an example, the beverage is a cocoa drink made of liquid fraction of brewer's spent grain and cocoa, sugar and salt. The dessert may for example be any of puddings, fromages, mousse, ice cream, sherbets, sorbets, ice milks, ice water and the like.

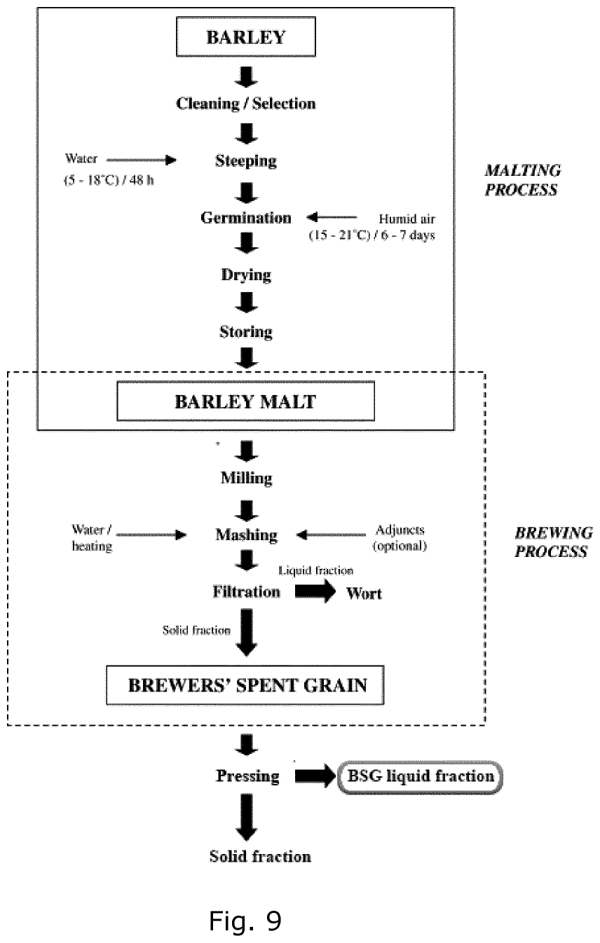

The term “brewer's spent grain” (BSG) refers to a by-product obtained from the process of brewing beer and distilling liquor from grains, sorghum, rice and corns, i.e. whiskey distillation. However, BSG may also come from the preparation of other types of liquor where grains, corn, rice or sugar canes is used as the starting material for preparing the liquor. An example is distillation of vodka from cereal grains that have been fermented. Other examples are distillation of rum from fermented sugar canes or arrack from sugar canes or rice. BSG is the insoluble solids obtained after malting and mashing in the brewing and destilling processes. Brewer's spent grain is a non-flowing product having a consistence similar to cooked oatmeal or wettend sawdust and may be referred to as a grain bed. Brewing beer requires only a few ingredients and can typically be divided into four steps or phases, namely the malting step, the mashing step, the fermentation step and the post-fermentation step. However, the malting step can be excluded if there is a need for reduction of expenses. Whiskey distillation also involves malting and mashing. In FIG. 9 is a schematically overview of the process of preparing brewer's spent grain in beer brewing shown. Further, FIG. 9 shows how the liquid fraction of brewer's spent grain is obtained by a mechanical separation treatment (here pressing) of the brewer's spent grain and hereby obtain a solid fraction of brewer's spent grain and a liquid fraction of brewer's spent grain.

During malting in beer brewing, the barley grains are soaked in water and hence allowed to germinate or sprout until a certain point which allows development of a wide range of enzymes (malting enzymes). The enzymes developed are amylases, proteases, and other enzymes. These enzymes will modify the structure of the barley endosperm by breaking down the cell walls and the protein matrix. After germination and sprouting of the barley grains, barley grains are subjected to a kilning step that stops the germination and development of enzymes. The kilning step most often 35 includes heat treatment. The kilning process provides roasting of the barley grains.

During the mashing step, the enzymes are released and used for hydrolysis of large macromolecules such as starch and protein. In the mashing step, the malted barley is milled and mixed with water and followed by a step-wise heating in order to break down starch and proteins into subunits that will function as substrate in the following fermentation process. It is believed that the flavouring ingredients are intensified during the mashing process. The step-wise heating is because the different enzymes synthesized during the malting step have optimal activity at different temperatures. At the end of the mashing step, a heat treatment is provided to inactivate the enzymes. Before fermentation, the insoluble solids from the mash is removed by filtration to obtain a mash liquid which is called the wort. The wort is used for the fermentation process in the beer production, where the insoluble solids removed is known as brewer's spent grain.

Brewer's spent grain (BSG) is thus the insoluble leftover obtained after wort production during brewing of beer and liquor destillation. BSG comprises grain solids, proteins, carbohydrates, and other materials, where the main solid components of BSG is the husk pericarp and seed coat of the malt, which are rich sources of lignin, cellulose, hemicellulose, lipids and protein. Of these components cellulose, hemicellulose and lignin comprises almost 50% of the dry matter content. The BSG also comprises a high amount of water. In BSG approximately 85% by weight is water, where approximately 15% by weight is solid materials. The water content in BSG comprises about 15% by weight free water, where the remaining water (about 85% by weight) is sucked into the grain material and thus not free flowing. In the present invention, BSG obtained after removal of the wort is termed as “raw BSG”. The “raw BSG” is the product that is subjected to a mechanical separation treatment to obtain a liquid fraction of brewer's spent grain.

Raw BSG is a great source of protein and fibre. Raw BSG may comprise a content of proteins in the range of 15-25% by weight of dry matter. BSG also comprises a high amount of dietary fibre, such as about 40-60% by weight of dry matter content.

The term “a liquid fraction of” a brewer's spent grain refers in the context of the present invention to the liquid obtained after a portion of brewer's spent grain has passed through a mechanical separation process, such that the brewer's spent grain is 35 pressed and hence separated into a liquid fraction and a solid fraction. By the term “fraction of BSG” is meant a “part” of the BSG. Hence, the term “liquid fraction of BSG” is the liquid part of BSG after raw BSG has been subjected to a mechanical separation process. Hence, in a preferred embodiment of the present invention the liquid fraction of brewer's spent grain is obtained by mechanically separation treatment of raw brewer's spent grain into a solid fraction and liquid fraction.

The liquid fraction of BSG may also be referred to as the wet fraction of BSG or BSG water. Furthermore, the term “liquid fraction of” a brewer's spent grain may be obtained by mechanical separation of the raw BSG. Using a sieve is not a mechanical separation and will not provide a separation into a liquid fraction and solid fraction, because most of the liquid is soaked into the grain material of the raw brewer's spent grains. However, the liquid fraction of BSG is obtained by separating raw BSG into a liquid fraction and a solid fraction by use of mechanical separation treatment. The mechanical separation treatment may for example be by use of a screw press, a filter press, a centrifuge or membrane filtration. Preferably, the mechanical separation treatment is by use of a screw press, a filter press or a centrifuge, because these separation methods press the raw brewer's spent grains such that the liquid can be separated in an increased amount. The centrifuge may in an embodiment be a decanter centrifuge.

In the context of the present invention, the term “raw BSG” refers to BSG from the brewing or distilling industry that has not been separated into a solid fraction and a liquid fraction. The raw BSG is the BSG obtained after filtrating the mash to obtain a wort and BSG. The liquid fraction of BSG will for example comprise soluble proteins and carbohydrates, as well as phenols.

In a preferred embodiment of the invention, the liquid fraction of BSG is obtained by separating raw BSG into a solid fraction and liquid fraction by use of a screw press and/or a centrifuge. Without being bound by any theory, the inventors of the present invention believes that the mechanical treatment of the BSG in a screw press or centrifuge increases degradation of the cell wall of the solid materials in the BSG, i.e. the solid materials of barley such as husk pericarp and seed coats. Hereby, further proteins and carbohydrates that was insoluble in the raw BSG is now released from the husk and seed coat and present in the BSG liquid fraction. On the contrary, the inventors of the present invention have found out that less nutrients was present in a BSG liquid fraction after use of a filter press as compared to after using a screw press or centrifuge. Without being bound by any theory, the inventors of the present invention believes that the mechanical treatment of of BSG may lead to that proteins and enzymes in the BSG is broken down into smaller peptides. Those smaller peptides may then link with carbohydrates to produce maillard products. The maillard products are obtained by linking the reducing end of carbonyl groups of carbohydrates with the amino acids of peptides or proteins during heating. Hence, if the mechanical treatment breaks the proteins into smaller peptides, more maillard products is obtained. Those obtained maillard products will contribute to an improved flavour of the liquid fraction of BSG as compared to BSG as such. Hence, the nutrient content of the liquid fraction of brewer's spent grain will be different than the nutrient content of for example a wort, because the mechanical separation in for example a screw press or centrifuge will release nutrients that are not obtained by simply filtrating the mash in a sieve.

In another preferred embodiment, the liquid fraction of brewer's spent grains does not comprises any added enzymes. By the term “any added enzymes” means that no exogenous enzymes is added, and only naturally occurring (endogenous) enzymes are present in the liquid fraction of brewer's spent grains.

In an embodiment of the present invention, the dry matter content of the liquid fraction of the brewer's spent grain is 20% by weight or less, such as 15% by weight or less. The dry matter content of the liquid fraction of the brewer's spent grain is preferably 10% by weight or less and even more preferably 8% by weight or less.

In a further embodiment of the invention, the dry matter content of the liquid fraction of the brewer's spent grain is in the range of 1% to 20% by weight, such as 2% to 15% by weight, preferably 3% to 10% by weight. In a most preferred embodiment of the invention, the liquid fraction of brewer's spent grain comprises a dry matter content in the range of 3% to 8% by weight.

In also an embodiment of the invention, the moisture content of the liquid fraction of brewer's spent grain is 80% by weight or more, preferably 85% by weight or more such as 90% by weight or more, preferably 92% by weight or more. In an additional embodiment of the invention, the moisture content of the liquid fraction of brewer's spent grain is in the range of 80% to 99% by weight, such as 8% to 98% by weight, preferably 90% to 97% by weight, most preferably 92% to 97% by weight.

By the term “moisture content” is in the context of the present invention meant the water content, where the water content comprises both free flowing water and bound water.

The liquid fraction of the brewer's spent grain comprises in a preferred embodiment a total amount of carbohydrate of 5% by weight or less. Preferably, the amount of carbohydrates in the liquid fraction of brewer's spent grain is 4% by weight or less, more preferably 3% by weight or less. On the contrary, the amount of total carbohydrates in a raw brewer's spent grain (unpressed) is about 10-13% by weight. BSG that have not been pressed will comprise a high amount of husk pericarp and seed coats that comprises a high amount of the carbohydrates lignin, cellulose and hemicellulose. After pressing the BSG, the husk pericarp and seed coats will be in the solid fraction. Further, cellulose, hemicellulose and lignin is insoluble in water and therefore only a small amount of cellulose, hemicellulose and lignin are present in the liquid fraction of BSG. Lignin, cellulose and hemicellulose belongs to the category of indigestible carbohydrates and therefore have no benefit for the human body to consume as they will not be digested (degraded in the human digestive system). Hence, with the mechanical separation process of raw BSG, a liquid fraction of BSG that comprises a lower amount of the indigestible carbohydrates is obtained, but the liquid fraction of BSG comprises fibres that can be digested in the human digestive system, and hence provide a good flora in the digestive system.

Furthermore, the liquid fraction of brewer's spent grain preferably comprises an amount of dietary fibres in the amount of 2% by weight or less, preferably 1% by weight or less, such as 0.8% by weight or less and even more preferably 0.5% by weight or less. On the contrary, raw BSG (not pressed) comprises a much higher amount of dietary fiber, such as above 5% by weight. Raw BSG (not pressed) typically comprises dietary fiber in an amount in the range of 5% to 10% by weight.

The dietary fibres in BSG is mainly hemicellulose, cellulose and lignin. Hemicellulose has greater digestibility than cellulose, while lignin normally is indigestible in the digestive system.

The protein content of the liquid fraction of brewer's spent grain will vary depending of the type of malt used in the brewing process of liquor distillation, as well as which filter is used during the brewing or distillation. However, the protein content is typically 3% by weight or less of the total content of the liquid fraction. Preferably, the protein content is 2.5% by weight or less, such as 2% by weight or less.

In an aspect of the present invention, the liquid food product comprises a liquid fraction of a brewer's spent grain in an amount in the range of from 10% to 100% by weight. In some countries, as the third world countries, there is water shortage. In fact, 785 10 million people worldwide lack access to safe and clean water. Hence, in those type of countries it would be an advantage to obtain liquid food products from other sources of liquid and hence from waste material from the brewing and distillation industry. Therefore, in an embodiment of the invention the liquid food product comprises a liquid fraction of a brewer's spent grain in an amount in the range of from 75% to 100% by weight, such as from 80% to 100% by weight, preferably from 90% to 100% by weight and more particularly essentially all liquid is from the liquid fraction of BSG. However, the present invention should not be limited to the amount of liquid fraction of BSG present in the liquid food product, since for some markets it could be relevant to add for example a fruit or vegetable juice to the liquid fraction of BSG. Hence, in another embodiment of the invention, the liquid food product comprises a liquid fraction of brewer's spent grain in the range of from 15% to 85% by weight, such as from 20% to 80% by weight. The amount of the liquid fraction of a brewer's spent grain in a liquid food product is not critical for the present invention and the liquid fraction of a brewer's spent grain can be used in a liquid food product in various amounts after desire. The inventors of the present invention have surprisingly found out that a liquid fraction of a brewer's spent grain have an improved taste and mouthfeel as compared to raw brewer's spent grain that has not been subjected to a mechanical separation process, such as pressing, decantering or centrifuging. Hence, the inventors of the present invention have found out how to use brewer's spent grains that otherwise is a waste product used as animal feed. By mechanical separation of the raw brewer's spent grains into a solid fraction and liquid fraction, the liquid fraction of brewer's spent grains can be used for preparing liquid food products, because the taste and mouthfeel of the liquid fraction of brewer's spent grains is improved as compared to the raw brewer's spent grains.

In an embodiment of the invention, the liquid food product furthermore comprises one or more flavour improving agent(s). By the term “flavour improving agent” is in the context of the present invention meant any compound, ingredient or composition that can be added to improve the flavour of the product.

For example, the flavour improving agent may be one or more selected from the group of an extract of an ingredient of vegetable material or animal material, fruit juice, vegetable juice, sweetener, syrup, flavouring agent, and spices.

However, in an embodiment of the invention, the liquid food product comprises a flavour improving agent selected from an extract of an ingredient of vegetable material and/or animal material. The liquid food product may however comprise additional flavour improving agents besides from such extract. In the context of the present invention, the term “extract of an ingredient of vegetable and/or animal material” means adding a material of vegetable and/or animal origin to the liquid fraction of BSG and perform an extraction process such that flavour from the vegetable or animal material is extracted into the liquid fraction of BSG or extracts flavour from the liquid fraction of BSG. The inventors of the present invention surprisingly found out that extraction of a vegetable and/or animal material in the liquid fraction of BSG not only provided added flavour compounds, but it also lead to reduction/removal of some unwanted flavour compounds present in raw BSG.

The inventors of the present invention have found out that making an extraction of for example a vegetable material in the liquid fraction of brewer's spent grains, the flavour profile of the liquid fraction of brewer's spent grains will change. Without being bound by any theory, the inventors of the present invention believes that polyphenols in for example vegetable leaves bind off-flavour compounds in the liquid fraction of brewer's spent grains and hence improves the flavour of the liquid fraction of brewer's spent grains.

The vegetable material should not be limited to any particular vegetable material and in principle any could be used. However, in a preferred embodiment, the liquid food product comprises an extract of an ingredient of vegetable material comprising polyphenols. The liquid food product hence comprises an extraction of a liquid fraction of brewer's spent grains and a vegetable material comprising polyphenols. In an even more preferred embodiment of the invention, the vegetable material is one or more selected from the group of plant leaves, flowerbuds, nuts, cereals, grains, seeds, needles from trees, peel from fruit, algae, mushrooms, seaweed, roots.

In a further embodiment, the vegetable material is selected from plant leaves, peel from fruit, nuts, roots and flower bud. Plant leaves are preferably black currant leaves and/or leaves from tea or coffee. The vegetable material may also be fermented tea, such as kombucha. Kombucha is fermented black or green tea. Peel from fruit is preferably peel from lemon or other citrus fruits. Nuts may for example be cocoa and/or coconut. Roots may for example be licorice (also licorice prowder is suitable) and flower buds may for example be vanilla and/or carnation.

In an embodiment of the present invention, the flavour improving agent is an extract of an ingredient of animal material. Preferably, the animal material is one or more selected from the group of meat broth, bone broth, animal guts or animal bowels.

In a further embodiment of the present invention, the liquid food product comprising a liquid fraction of brewer's spent grain may also comprise added water, but this does not include using of raw BSG diluted in water. In a preferred aspect of the present invention, the liquid food product does not comprise any raw BSG or any raw BSG diluted in water. This is an important feature of the present invention, that only a liquid fraction of BSG is used in the liquid food product and not raw BSG, since raw BSG for example has an unpleasant flavour compared to the liquid fraction of BSG and since raw BSG comprises more indigestible fibres that can not be digested by the human body than the liquid fraction of BSG. Such fibre include lignin, cellulose and hemicellulose and provides no nutritional beneficial effect to the human body. Hence, the liquid fraction of brewer's spent grain is obtained by mechanically separation of raw BSG only. Raw BSG suspended in water does not fall under the definition of a “liquid fraction of brewer's spent grain”. However, the liquid food product of the present invention comprising the liquid fraction of BSG as a base component could comprise other beverages or liquids, for example a juice.

The term “flavour” refers to the combined effect of taste and smell (odour), while the term “aroma” refers to odour/smell only.

In an embodiment of the invention, the liquid food product comprises a) a flavour improving agent selected from an extract of an ingredient of vegetable material and/or animal material and b) a further flavouring improving agent selected from the group of fruit juice, vegetable juice, sweetener, syrup, flavouring agent, and spices.

If a sweetener is added, it may be any type of sweetener, for example a natural sweetening agent, a sugar, a syrup, vanilla or a high intense sweetener. In an embodiment, the liquid food product comprises a) a flavour improving agent selected from an extract of an ingredient of vegetable material and/or animal material and b) a fruit juice and/or a vegetable juice.

The present invention is not limited to any particular type of fruit or vegetable juice. Hence, the fruit and vegetable juice may be a juice of any type of fruit and vegetable. The fruit or vegetable juice is typically prepared by placing chopped fruit pieces, chopped vegetables or berries in a slow juicer at room temperature and mix to prepare a juice. The preparation of juices is preferably performed at room temperature to release the juice of the vegetable, fruit or berry.

The fruit used for juice may for example be, but is not limited to, apples, pears, plums, oranges, grapes, mango, banana, apricot, peaches, and melon.

The berries used for juice may be, but is not limited to, strawberries, raspberry, cranberries, lingonberries, sea buckthorn, blueberries, blackberries, red currant berries, aronia berries and blackcurrant berries.

Further, the vegetable used for juice may for example be, but is not limited to, tomato, cucumber, carrot, fennel, ginger, spinach, beetroot, broccoli, cauliflower, celery, courgette, leek, bean, pea, pumpkin, and yam.

In addition to a flavour improving agent, the liquid food product may also comprise preservative(s) and/or colouring agent(s).

The Method of Preparing a Liquid Food Product of the Invention

In an aspect, the present invention relates to a method of preparing a liquid food product comprising the steps of:
i) providing a liquid fraction of brewer's spent grain;
ii) optionally adding further ingredients;
iii) subject the liquid fraction of brewer's spent grain to a step of inactivating unwanted microorganisms; and
   hereby obtain the liquid food product.

In a preferred embodiment of the invention, the liquid fraction of brewer's spent grain is obtained by mechanically separation of raw brewer's spent grains into a solid fraction and liquid fraction. The mechanically separation is preferably by use of a screw press, a filter press, a centrifuge, or membrane filtration.

In the context of the present invention, the term “unwanted microorganisms” is microorganisms present that is not healthy to human consumption and may lead to a decreased storage time of the liquid food product obtained.

The inactivation of unwanted microorganisms in step iii) of the method may for example be by a heat treatment, adjusting pH or by addition of probiotic bacteria. With inactivation of unwanted microorganisms, the storage time of the liquid food product will be increased.

Probiotic bacteria may for example include multi-species cultures such as, but is not limited to, kombucha culture and kefir culture. Probiotic bacterias used may also be lactic acid bacterias or acetic acid bacterias. Examples of Lactic acid baterias are selected from the genus Lactobacillus, the genus Streptococcus, the genus Bifidobacterium, the genus Lactococcus, the genus Propionibacterium, the genus Pediococcus and the genus Leuconostoc. Examples of acetic acid bacteria are selected from the genus Gluconobacter and the genus Acetobacter.

When adding probiotic bacteria, the probiotic bacteria will dominate over the harmful bacteria such that the growth conditions for the harmful bacterias will be minimized.

Heat treatment to inactivate unwanted microorganisms may for example be in the form of a pasteurization step, an ultra high temperate (UHT) treatment or high pressure pasteurisation (HPP). The heat treatment step is used to inactivate unwanted microorganisms if present. However, the type of heat treatment, the temperature and time of heating is not important for the present invention.

If a pasteurization step is used, the pasteurization will preferably be at 65° C. to 90° C. for 5 seconds to 5 minutes, preferably 70° C. to 80° C. for 5 seconds to 5 minutes, such as at 70° C. to 80° C. for 10 seconds to 30 seconds. On the contrary, if an UHT treatment is used it will preferably be at 110° C. to 140° C. for 1-5 seconds, preferably for 2-4 seconds. Pasteurization is the process of heating to a specific temperature to slow microbial growth in the food. Sterilization on the contrary refers to the process of eliminating all forms of bacteria from any product.

In a further embodiment the, liquid fraction of brewer's spent grain is subjected to a heat treatment for a period of time sufficient to remove unwanted flavour compounds. Such heat treatment could be the same as the heat treatment for inactivating unwanted microorganisms, but it could also be two separate heat treatment steps. The heat treatment for removing unwanted flavour compounds is preferably at 90-98° C. for at least 5 minutes. The temperature should not exceed 100° C. as bitter compounds may be developed at temperatures above 100° C.

In an embodiment of the invention, the liquid fraction of brewer's spent grain has a dry matter content of 15% by weight or less. The dry matter content of the liquid fraction of the brewer's spent grain is preferably 10% by weight or less and even more preferably 8% by weight or less.

In a further embodiment of the invention, the dry matter content of the liquid fraction of the brewer's spent grain is in the range of 1 to 20% by weight, such as 2 to 15% by weight, preferably 3 to 10% by weight. In a most preferred embodiment of the invention the liquid fraction of brewer's spent grain comprises a dry matter content in the range of 3 to 8% by weight.

In an embodiment of the invention, one or more flavour improving agent(s) is/are added to the liquid fraction of brewers spent grain before or after the step of inactivating the unwanted microorganisms. The flavour improving agent(s) is/are one or more selected from the group of an extract of an ingredient of vegetable material and/or animal material, fruit juice, vegetable juice, sweetener, syrup, flavouring agent, and spices. In a preferred embodiment of the invention, the method of preparing a liquid food product comprises adding a flavour improving agent selected from an extract of an ingredient of vegetable material and/or animal material.

Hence, in a preferred embodiment the method of preparing a liquid food comprises the steps of:
i) providing a liquid fraction of a brewer's spent grain
   adding one or more flavour improving agent(s) selected from the group of an ingredient of vegetable material or animal material to the liquid fraction of brewer's spent grain to provide a mixture and perform an extraction of the mixture;
ii) optionally adding one or more further ingredients;
iii) subject the extracted mixture of step i) or step ii) to a step of inactivating unwanted microorganisms in the mixture; and
   hereby obtain the liquid food product.

In the context of the present invention, the term “ingredient of vegetable material or animal material” should be understood as an ingredient of vegetable or animal origin that upon extraction could improve the flavour (taste and aroma) of a liquid composition either by adding flavour compounds or by removing unpleasant tasting flavour compounds.

For example, the one or more ingredient of vegetable material may for example be selected from the group of plant leaves, nuts, cereals, grains, seeds, needles from trees, peel from fruit, algae, mushrooms, seaweed, roots. However, the invention should not to be limited to any particular material of vegetable origin, but to a vegetable material that provides an improved or amended flavour to the liquid fraction of BSG after an extraction. The improved or amended flavour may both be added flavour components or to remove flavour compounds during the extraction step.

In a preferred embodiment, the one or more ingredient of vegetable material may be plant leaves, needles from trees, or peel from fruit. In particular, plant leaves and peel from fruit that have a fruity flavour. Plant leaves may for example be leaves from blackcurrant or leaves from cheery trees but may also be leaves from other trees.

The one or more ingredient of vegetable material may be either fresh vegetable material, dried or frozen vegetable material, but preferably it is a dried vegetable material such as dried plant leaves.

In a preferred embodiment of the invention, the flavour improving agent is an extract of dried black currant leaves.

The one or more ingredient of vegetable material may be added to the liquid fraction of brewer's spent grain in an amount of from 0.2 to 400 g/L dependent of the type of vegetable material used and the intensity of flavour from the vegetable material is wished. For example, if plant leaves are used as the vegetable material, it is used in an amount of 0.2 g to 5.0 g dried plant leaves per litre liquid fraction of brewer's spent grain. If needles of trees, peel from fruit, algae, mushroom or seaweed is used as vegetable material, it is preferably also in dried form and in an amount of from 0.2 to 5 g/L. In a preferred embodiment, dried plant leaves, peel from fruit, needles of trees, algae, mushroom or seaweed is used in an amount of 0.5 to 5.0 g/L of a liquid fraction of a brewer's spent grain. If nuts, grains, cereals, seeds or roots are used as the vegetable material, they are preferably used in an amount of 50 to 400 g per litre liquid fraction of brewer's spent grain, such as in an amount of 75 to 300 g/L, preferably in an amount of 100 to 250 g/L.

Also one or more ingredient of animal material may be used as a flavour improving agent, such as meat broth, bone broth, animal guts or animal bowels. The amount of animal material used in the present invention as flavour improving agent may vary a lot dependent of the material used and is not to be seen as a limitation of the present invention. However, animal meat and/or bone is typically used in an amount of 0.3 to 1.5 kg per litre liquid fraction of brewer's spent grain. In an example, animal meat and/or bones is used in an amount of about 2 kg per 3 litre liquid fraction of brewer's spent grain. The use of an animal material, in the preparation of a liquid food product comprising a liquid fraction of BSG, is typically for the preparation of a soup. Such soup may typically besides from a liquid solution of BSG comprise a meat or bone broth and a vegetable juice, but a soup may also be prepared by extracting a liquid fraction of BSG comprising guts or bowels from animals to extract the flavour from said guts or bowels.

In a further preferred embodiment, the flavour improving agent is an extract of an ingredient of vegetable and/or animal material in combination with one or more of a juice, sweetener, syrup, and spices, preferably a juice.

When a vegetable or animal material is used as the flavour improving agent, an extraction is performed to either extract the flavour of the vegetable or animal material into the liquid fraction of BSG or to remove some flavour compounds from the liquid fraction of BSG.

In an embodiment, the extraction of the vegetable or animal material is carried out by heating the mixture of liquid fraction of BSG and vegetable and/or animal material to a temperature of 72° C. to 120° C. for a period of 2 to 60 minutes dependent of the temperature used and the vegetable material used. The extraction may for example be carried out at a temperature of 75° C. to 115° C., preferably at a temperature of 80° C. to 110° C., such as 85° C. to 100° C. In a preferred embodiment of the invention, the extraction is carried out just below the boiling point of the mixture. If the boiling point is exceeded, bitter compounds may be developed. Hence, the extraction is typically carried out by heating to a temperature of 72° C. to 99° C., such as 75° C. to 98° C. and more preferably at 85° C. to 98° C. The time of extraction is typically for 2 to 60 minutes dependent of the temperature used, such as 5 to 30 minutes. If the temperature is about 85° C. to 98° C., the time of extraction is typically about 15-20 minutes.

An example of such extraction is addition of about 1-2 g dried leaves from blackcurrant to 1 liter of a liquid fraction of brewer's spent grain (BSG). The mixture is then heated to a temperature of 75° C. to 120° C. for about 15-30 minutes to extract flavour compounds of the blackcurrant leaves into the liquid and remove other flavour compounds from the liquid fraction of BSG.

In another embodiment, the extraction of flavour from the vegetable or animal material is carried out by cooling the mixture to a temperature of 10° C. or below and extract at that temperature for at least 10 hours. Preferably, the extraction by cooling is carried out by cooling the mixture to a temperature of 2° C. to 10° C. for a period of time of 10 to 48 hours. The time of the extraction by cooling is not critical and the invention should not be limited to any time of extraction. Hence, in principle the mixture with vegetable and/or animal material could be left at a temperature of 2° C. to 10° C. for a longer time, such as one to two weeks.

After extraction of vegetable and/or animal material, the vegetable and/or animal material is removed from the mixture. The vegetable and/or animal material may be mixed directly into the liquid fraction of BSG or placed in a filter where said filter is placed in the liquid fraction of BSG. If the vegetable and/or animal material is placed in a filter, the vegetable and/or animal material is removed from the mixture by removing the filter. However, if the vegetable and/or animal material is added directly into the liquid fraction of BSG, the mixture has to be filtered to remove the vegetable and/or animal material and hence stop the extraction.

In the embodiments of the invention, where vegetable and/or animal material is added and extraction is obtained by a heat treatment step, this heat treatment step of the extraction and the heat treatment of step iii) to inactivate unwanted microorganisms may be the same.

In a further embodiment of the invention, the liquid food product obtained after extraction in step i) and before inactivating unwanted microorganisms in step iii) is added additional liquid fraction of brewer's spent grain.

After the extraction of flavour from vegetable and/or animal material, further ingredients may be added to the liquid fraction of BSG before the heat treatment in step iii). Further ingredients to be added may for example be adding further liquid fraction of BSG, a juice, sweeteners, colourings, preservatives, stabilizers and/or emulsifiers. Preferably, if a juice is added, it is a juice of one or more of fruits, berries and vegetables. In a preferred embodiment of the invention, the liquid food product is prepared by extraction with a vegetable and/or animal material, removal of the vegetable and/or animal material, followed by addition of a juice. Addition of a juice will typically be added after an extration with an ingredient of vegetable and/or animal material.

In an embodiment of the present invention, a juice is added to the mixture in step ii) in a ratio between juice and the mixture of maximum 80:20, such as maximum 75:25.

In an embodiment of the present invention, the liquid fraction of BSG is obtained by separation of raw BSG into a liquid fraction and a solid fraction by mechanical separation. The separation may for example be by use of a screw press, a filter press, a centrifuge or membrane filtration. However, preferably the separation of BSG into a liquid fraction and solid fraction is by use of a screw press and/or a centrifuge.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1—Content of Nutrients in Raw BSG Versus Liquid Fraction of BSG

An analysis of different nutrients have been measured in a liquid fractions of brewer's spent grain (BSG) and compared to the content of the same nutrients in a raw brewers spent grain that has not been separated into a liquid fraction and solid fraction. The liquid fraction of BSG has been made by pressing raw BSG by use of a screw press. The raw brewer's spent grain used is from production of a lager beer. In table 1 below, the nutrient content is shown.

TABLE 1

| | | Liquid fraction | |
|---|---|---|---|
| | | of BSG | Raw BSG |
| Moisture | g/100 g | 95.4 | 82.1 |
| Protein | g/100 g | 1.84 | 3.98 |
| Total fat | g/100 g | 0.6 | 1.7 |
| Saturated FA | g/100 g | 0.21 | 0.43 |
| Monounsat. FA | g/100 g | 0.07 | 0.2 |
| Polyunsat. FA | g/100 g | 0.30 | 0.99 |
| Ash | g/100 g | 0.1 | 0.6 |
| Total carbohydrates | g/100 g | 2.1 | 11.6 |
| Total dietary fibre | g/100 g | <0.5 | 8.2 |
| Available carbohydrates | g/100 g | 2.1 | <0.1 |
| Energy | Kcal/100 g | 21 | 61 |
| Energy | KJ/100 g | 88.5 | 254 |
| Sodium | Mg/100 g | 23.1 | 32.8 |

The determination of the different nutrients is determined by the company ALS Denmark by use of the methods mentioned in table 2:

TABLE 2

| | Method |
|---|---|
| Moisture | AOAC 16 Ed. |
| Protein | Dumas Leco Nitrogen |
| Total fat | NMR |
| Saturated FA | BS/EN ISO 12966-2 2011 + ISO 5509-1990 |
| Monounsat. FA | BS/EN ISO 12966-2 2011 + ISO 5509-1990 |
| Polyunsat. FA | BS/EN ISO 12966-2 2011 + ISO 5509-1990 |
| Ash | BS 4401 Part 1 1998 Com. Reg. 152/2009 |
| Total carbohydrates | Council Directive 90/496/EEC |
| Total dietary fibre | AOAC 985.29 |
| Available carbohydrates | Council Directive 90/496/EEC |
| Energy (KJ/100 g) | Council Directive 90/496/EEC |
| Energy (kcal/100 g) | Council Directive 90/496/EEC |
| Sodium | Feedingstuffs Reg. 2004 + ICP |

### Example 2—Comparing Flavour of Raw BSG Versus Liquid Fraction of BSG

In example 2, the flavour and mouthfeel of two samples of the following was evaluated:
i) Raw BSG
ii) Raw BSG diluted with 50 wt-% water
iii) Raw BSG diluted with 50 wt-% water and grinded
iv) Liquid fraction of BSG
v) Liquid fraction of BSG with 50 wt-% water
vi) Liquid fraction of BSG with 50 wt-% water—boiled for 15min at 98° C.

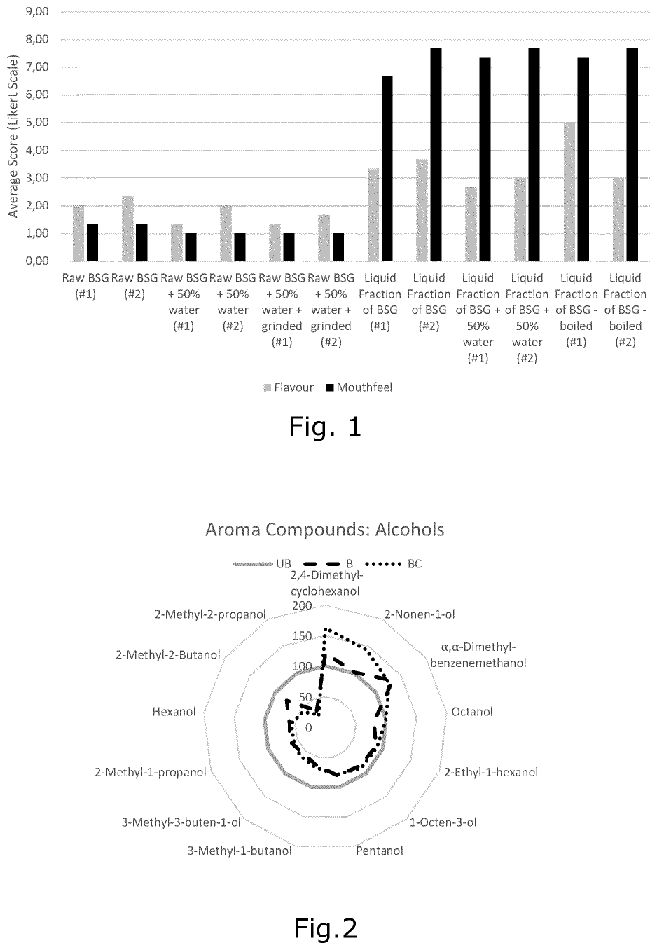

The six samples was placed in two separate cups and the 2×6 samples was randomly served to a panel of 5 trained panellists. The sensory panel was trained to test different flavouring compounds, i.e. bitter, sweet, sour and salt, as well as the mouthfeel. The panellist scored the samples from 1 to 10, both with regard to flavour and to mouthfeel. The result of the evaluation is showed in FIG. 1.

Mouthfeel refers to the physical sensation in the mouth caused by food or drink, as distinct from taste.

FIG. 1 shows that the flavour of a liquid fraction of BSG and diluted liquid fraction of BSG was found to have a significant improved flavour as compared to raw BSG and in particular to diluted raw BSG which has been grinded. FIG. 1 also shows that the mouthfeel of a liquid fraction of BSG and diluted fraction of BSG was found to have a significant and largely improved mouthfeel as compared to raw BSG, raw diluted BSG and raw diluted and grinded BSG.

### Example 3—Preparation of Beverage with Liquid Fraction of BSG Water Extracted with Blackcurrant Leaves

Example 3 shows the preparation of a beverage according to the invention by use of a liquid fraction of BSG extracted with blackcurrant leaves.

A brewer's spent grain from the production of a lager beer is pressed in a screw press. Hereby the raw brewer's spent grain is separated into a solid fraction and a liquid fraction. Approximately 2 g of dried blackcurrant leaves is added to 1 litre of the liquid fraction of brewer's spent grain and the mixture is heated to approximately 98° C. for about 15 minutes to both extract flavour from the blackcurrant leaves into the liquid and for the black current leaves to abstract unwanted flavours from the fraction. The blackcurrant leaves are removed and the obtained beverage is cooled before filled into bottles. In this example, the heat treatment during extraction also function as the step of inactivating the unwanted microorganism.

### Example 4—Comparing the Content of Aroma Compounds in Different Treatments of Liquid Fractions of Brewer's Spent Grains

A brewer's spent grain from production of lager beer is pressed in a screw press such that the raw brewer's spent grain is separated into a solid fraction and a liquid fraction. Samples are taken of the liquid fraction of brewer's spent grain where it is boiled and unboiled. Further, samples are taken of an extract of a liquid fraction of brewer's spent grain with blackcurrant leaves according to example 3. The parameters of different samples are shown in table 3 below.

TABLE 3

| | Bottle 1 | Bottle 2 |
|---|---|---|
| Unboiled | Unboiled 1 | Unboiled 2 |
| Boiled | Boiled 1 | Boiled 2 |
| | Tᵢₙᵢₜᵢₐₗ = 17.6° C., | Tᵢₙᵢₜᵢₐₗ = 17.2° C., |
| | T_{end} = 86.0° C. | T_{end} = 85.0° C. |
| Extracted with | Blackcurrant 1 | Blackcurrant 2 |
| blackcurrant leaves | Tᵢₙᵢₜᵢₐₗ = 20.0° C., | Tᵢₙᵢₜᵢₐₗ = 20.0° C., |
| | T_{end} = 84.4° C. | T_{end} = 84.4° C. |

Each of the six samples were analyzed for aroma compounds (unboiled, boiled and boiled with blackcurrant leaves). For the analysis, dynamic headspace extraction and Gas chromatography-mass spectrometry (GC-MS) was used. From each sample, 20 ml sample/suspension was transferred to a 150 ml gas washing flask, and then put in a 37° C. circulating water bath. After samples reached equilibrium, they were then purged with nitrogen (100 mL min-1) for 20 min with magnetic stirring (200 rpm). Volatile compounds were then trapped on Tenax-TA traps containing 200 mg of Tenax-TA with mesh size 60/80. After purging, water was removed from the traps with a flow 100 mL dry nitrogen pr. minute for 10 min.

The trapped volatiles were desorbed using an automatic thermal desorption unit (TurboMatrix 350, Perkin Elmer, Shelton, USA). Primary desorption was carried out by heating the trap to 250° C. with a flow (50 mL min-1) of carrier gas for 15.0 min. The stripped volatiles were trapped in a Tenax TA cold trap (30 mg held at 5° C.), which was subsequently heated at 300° C. for 4 min (secondary desorption, outlet split 1:10). This allowed for rapid transfer of volatiles to a gas chromatograph-mass spectrometer (GC-MS, 7890A GC-system interfaced with a 5975C VL MSD with Triple-Axis detector from Agilent Technologies, Palo Alto, Calif.) through a heated (225° C.) transfer line. Separation of volatiles was carried out on a ZB-Wax capillary column 30 m long×0.25 mm internal diameter, 0.50 μm film thickness. The column pressure was held constant at 2.3 psi resulting in an initial flow rate of 1.4 mL min-1 using hydrogen as carrier gas. The column temperature program was: 10 min at 30° C., from 30° C. to 240° C. at 8° C. min-1, and finally 5 min at 240° C.

The mass spectrometer was operating in the electron ionization mode at 70 eV. Mass-to-charge ratios between 15 and 300 were scanned.

Peak areas and mass spectra were extracted from the chromatograms using the PARAFAC2 based software PARADISe and mass spectra were identified using the NISTO5 database. Peak areas were used as relative measures of concentration. Volatile compound identification was confirmed by comparison with retention indices (RI) of authentic reference compounds or retention indices reported in the literature.

In total 44 aroma compounds were identified in the samples, divided in the categories Alcohols (e.g. 2-Methyl-2-Propanal, 1-Octen-3-ol, Hexanol), Aldehydes (e.g. Hexanal, 2-Methylbutanal, Pentanal), Ketones (e.g. 2-Heptanone, 2,3 Butanedione), Acids (e.g. Acetic acid, Butanoic Acid), and others (Benzonitrile, 2-pentyl-furan, Ethyl Acetate, and Eucalyptol).

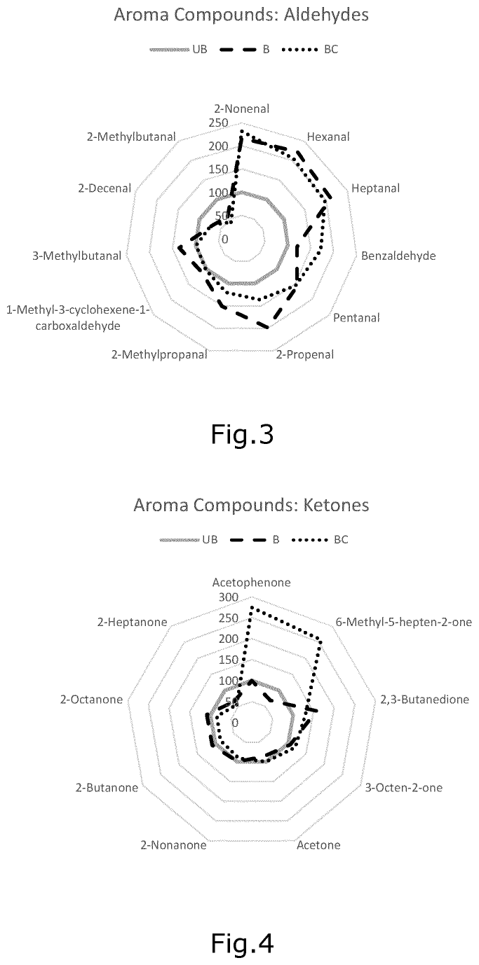

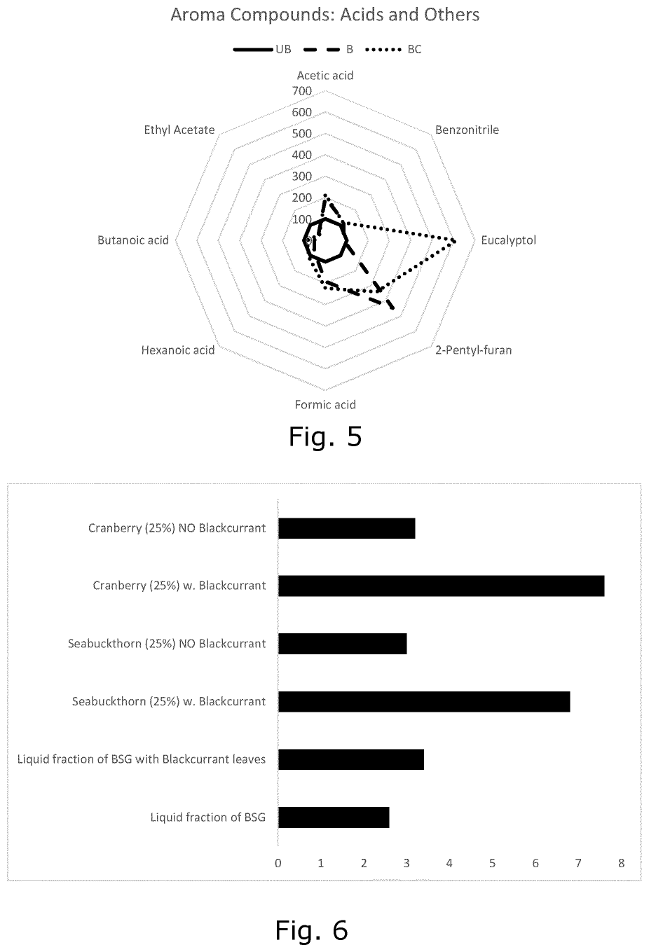

In FIG. 2, FIG. 3, FIG. 4 and FIG. 5, the average of each of the pair of samples (Unboiled liquid fraction of brewer's spent grain (UB), boiled liquid fraction of brewer's spent grain (B) and liquid fraction of brewer's spent grain boiled with blackcurrant leaves (BC)) are presented in spiderweb, where the UB is taken as index 100, and then calculate the index value for each aroma compound for both Boiled liquid fraction of brewer's spent grain and liquid fraction of brewer's spent grain Boiled with blackcurrant leaves:

B_n(index)=(AromaCompound_n(Boiled)/AromaCompound_n(Unboiled))*100.

For liquid fraction of brewer's spent grain boiled with blackcurrant, the results is also presented as an index measure in relation to the unboiled:

BC_n(index)=Aromacompound_n(Boilded_BC)/Aromacompound_n(Unboiled))*100.

This means that for any aroma compound that has a lower index value than the unboiled sample, the aroma compound is less represented, where as if there has been an increase in the aroma compound it will be represented by an increase in comparison to unboiled, which is shown in the FIGS. 2 to 5 as index 100.

In FIG. 2 that presents the aroma compounds that are alcohols, it is clearly shown that the effect of boiling (B) as well as boiling with black currant leaves (BC). Aroma compounds, such as 3-Methyl-1-butanol and 2-Methyl-1-propanal which are off-flavours decreases to half or under half of the level for the unboiled liquid. Whereas other flavours, not accounted for as off-flavors increase (e.g. a, a-dimethylbenzenemethanol which is characterized by a mild, green, sweet, earthy flavour or 2-nonen-1-ol which represents flavors of Fatty, green, melon, cucumber, vegetable).

In FIG. 3, the indexed results from aldehydes are shown. Again the effect from boiling and boiling with blackcurrant leaves becomes clear. A number of aroma compounds increase, e.g. Hexanal, Heptanal and Benzaldehyde, which all three (among other aroma characteristics) are characterized as fruity.

In FIG. 4, the indexed results from the ketones are shown, again clear differences in between unboiled, boiled, and boiled with blackcurrants are shown. 2-Octanone is characterized by blue cheese flavor, as seen in the spider diagram, the amount of the aroma compound 2-Octanone decreases when boiled with black currant leaves, whereas the boiled samples aren't affected. While this aroma compound is well liked in cheese, this flavour is unwanted in drinks, and could be one of the main differences as to why the sensory panel scores the liquid fraction boiled with black currant leaves higher than only boiled.

In FIG. 5, the indexed results from acids and other aroma compounds detected in the unboiled, boiled, and boiled with black currant leafs samples are shown. Eucalyptol is clearly related to BC sample, represented by pleasant odors of eucalyptos, champhor, fresh, pungent, whereas 2-Pentyl-Furan (green, bean, butter, earthy, vegetable) increases in both the boiled and boiled with black currant leaves samples.

All together, FIGS. 2 to 5 outline the complexity in how the aroma compounds are influenced, and show the added value of not only boiling the liquid fraction of brewers spent grains, but also including effectful ingredients, such as black currant leaves (or e.g. citrus, carnation, cacao, cocoa, coffee, tea, peppermint, licorice), that interact with the aroma compounds available in the liquid fraction of brewers spent grains.

### Example 5—Preparation of Beverage with Liquid Fraction of BSG Extracted with Blackcurrant Leaves and Added and Different Juice

Example 5 shows how to prepare a beverage according to the invention by use of a liquid fraction of BSG extracted with blackcurrant leaves and afterwards addition of a juice.

A raw brewer's spent grain is pressed in a screw press as mentioned in example 3. Approximately 2 g of dried blackcurrant leaves is added to 1 litre of the liquid fraction of brewer's spent grain and the mixture is heated to approximately 98° for about 15 minutes to extract flavour from the blackcurrant leaves into the liquid. The blackcurrant leaves are removed.

Samples of liquid fraction of BSG extracted with blackcurrant leaves are obtained and different juices of fruit and/or berry (and different amounts) are added in an amount of 3 parts blackcurrant extracted BSG water and 1 part juice.

The different samples are as follows:
Sample 1: Liquid fraction of BSG
Sample 2: Liquid fraction of BSG extracted with blackcurrant leaves
Sample 3: Liquid fraction of BSG extracted with blackcurrant leaves and mixed with juice of sea buckthorn in the ratio of 3:1 (75% extracted liquid BSG fraction and 25% sea buckthorn juice)
Sample 4: Liquid fraction of BSG extracted with NO blackcurrant leaves and mixed with juice of sea buckthorn in the ratio of 3:1 (75% extracted liquid BSG fraction and 25% sea buckthorn juice)
Sample 5: Liquid fraction of BSG extracted with blackcurrant leaves and mixed with cranberry juice in the ratio of 3:1 (75% extracted liquid BSG fraction)
Sample 6: Liquid fraction of BSG extracted with NO blackcurrant leaves and mixed with cranberry juice in the ratio of 3:1 (75% extracted liquid BSG fraction)

When mentioned “extraction with NO blackcurrant leaves” is meant that no blackcurrant leaves was added, but the liquid fraction of BSG was still heated to 98° C. for 15 min before the juice was added. Sensory evaluation was made with a test panel of 5 panelist scoring the taste of the samples from 1 to 10, where 10 is the best. The result is shown in FIG. 6.

FIG. 6 shows that a beverage made of liquid fraction of BSG extracted with blackcurrant leaves had an improved flavour as compared to the flavour of liquid fraction of BSG. FIG. 6 also shows that addition of a juice (seabuckthorn, cranberry or aronia) resulted in an even further improved flavour. However, FIG. 6 also shows clearly that the flavour is not merely improved by addition of a juice, because the beverage made of a liquid fraction of BSG not extracted with blackcurrant juice had a significantly less good flavour than liquid BSG extracted with blackcurrant juice and added the same type of juice. Hence, FIG. 6 clearly shows the improved effect on the taste when a liquid fraction of BSG is extracted with blackcurrant leaves.

### Example 6 Shows the Sensoric Evaluation of Extraction with Other Vegetable Materials

Example 6 shows how to prepare a beverage according to the invention by use of a liquid fraction of BSG extracted with different vegetable material. As examples is beverages extracted with the following vegetable material in a liquid fraction of BSG tested; citrus peel, coconut, vanilla and cocoa. A raw brewer's spent grain (raw BSG) is pressed in a screw press as mentioned in example 3 to obtain a liquid fraction of BSG.

Test with Citrus Peel:

Citrus peel was added to 3 decilitre of liquid fraction of brewer's spent grain in amounts of ½ teaspoon (about 0.04 g), ¼ teaspoon (about 0.02 g) and 1/8 teaspoon (about 0.01 g). The mixtures were heated to approximately 98° C. for about 15 minutes to extract flavour from the citrus peel into the liquid. The citrus peel is removed. For comparing, samples were also made of a beverage with liquid fraction of brewer's spent grains without adding citrus peel, boiled and unboiled. Sensory evaluation was made with a test panel of 5 panelist scoring the taste of the samples from 1 to 10, where 10 is the best. The result is shown in table 4 below:

TABLE 4

| Sample | Score |
|---|---|
| With ⅛ tsp citrus peel | 4 |
| With ¼ tsp citrus peel | 3 |
| With ½ tsp citrus peel | 2 |
| Boiled, no citrus peel | 3 |
| Unboiled, no citrus peel | 1 |

Hence, with a low amount of extracted citrus peel, the taste of the liquid fraction of brewer's spent grain is improved. It was shown that with a low amount of extraction with citrus peel, the off-flavour of the liquid fraction of brewer's spent grain was removed. When the amount of citrus peel, on the contrary, was too high, the taste of the citrus became too dominant and the taste conceived as less pleasant.

Test with Coconut:

Coconutflour was added to 1 decilitre of liquid fraction of brewer's spent grain in amounts of 1 g, 2 g and 4 g. The mixtures were heated to approximately 98° C. for about 8 minutes to extract the flavour from the coconutflour into the liquid. The coconut flour was removed. For comparing, samples were also made of a beverage with liquid fraction of brewer's spent grains without adding coconutflour, boiled and unboiled. Sensory evaluation was made with a test panel of 5 panelist scoring the taste of the samples from 1 to 10, where 10 is the best. The result is shown in table 5 below:

TABLE 5

| Sample | Score |
|---|---|
| With 4 g coconut flour | 5 |
| With 2 g coconut flour | 7 |
| With 1 g coconut flour | 4 |
| Boiled, no coconut flour | 3 |
| Unboiled, no coconut flour | 1 |

Test with Cocoa:

Cocoa was added to 2 decilitre of liquid fraction of brewer's spent grain in amounts of 1 g, 2 g, and 4 g. The mixtures were heated to approximately 98° C. for about 6 minutes.

The boiled liquid fraction with ingredients is then sieved to remove cocoa. For comparing, samples were also made of a beverage with liquid fraction of brewer's spent grains without adding cocoa. Sensory evaluation was made with a test panel of 5 panelist scoring the taste of the samples from 1 to 10, where 10 is the best. The result is shown in table 6 below:

TABLE 6

| Sample | Score |
|---|---|
| With 4 g cocoa | 4 |
| With 2 g cocoa | 6 |
| With 1 g cocoa | 4 |
| Boiled, no cocoa | 3 |
| Unboiled, no cocoa | 1 |

Test with Vanilla:

Vanilla was added to 2 decilitre of liquid fraction of brewer's spent grain in amounts of 1.5 g, 3 g, and 4.5 g. The mixtures were heated to approximately 98° C. for about 6 minutes to extract flavour from the vanilla into the liquid. For comparing, samples were also made of a beverage with liquid fraction of brewer's spent grains without adding ingredients. Sensory evaluation was made with a test panel of 5 panelist scoring the taste of the samples from 1 to 10, where 10 is the best. The result is shown in table 7 below:

TABLE 7

| Sample | Score |
|---|---|
| With 4.5 g vanilla | 7 |
| With 3 g vanilla | 5 |
| With 1.5 g vanilla | 4 |
| Boiled, no vanilla | 3 |
| Unboiled, no vanilla | 1 |

Test with Carnation:

Dried carnation was added to 2 decilitre of liquid fraction of brewer's spent grain in amounts of 1piece (whole dried carnation), 3pieces, and 5pieces. The mixtures were heated approximately 98° C. for about 6 minutes to extract flavour from the carnation into the liquid. For comparing, samples were also made of a beverage with liquid fraction of brewer's spent grains without adding ingredients. Sensory evaluation was made with a test panel of 5 panelist scoring the taste of the samples from 1 to 10, where 10 is the best. The result is shown in table 8 below:

TABLE 8

| Sample | Score |
|---|---|
| With 5 dried carnation | 3 |
| With 3 dried carnation | 5 |
| With 1 dried carnation | 3 |
| Boiled, no carnation | 3 |
| Unboiled, no carnation | 1 |

Test with Licorice Powder:

Licorice powder was added to 2 decilitre of liquid fraction of brewer's spent grain in amounts of 1/10 tsp (0.3 g dried carnation), 5/10 tsp (1.5 g), and 1 tsp (3 g). The mixtures were heated to approximately 98° C. for about 6 minutes to extract flavour from the licorice into the liquid. For comparing, samples were also made of a beverage with liquid fraction of brewer's spent grains without adding ingredients. Sensory evaluation was made with a test panel of 5 panelist scoring the taste of the samples from 1 to 10, where 10 is the best. The result is shown in table 9 below:

TABLE 9

| Sample | Score |
|---|---|
| With 0.3 g licorice powder | 6 |
| With 1.5 g licorice powder | 4 |
| With 3 g licorice powder | 4 |
| Boiled, no licorice powder | 3 |
| Unboiled, no licorice powder | 1 |

### Example 7—GC-MS Tests of Chemical Flavour and Aroma Compound in Beverages

In example 7, samples was analysed for different chemical compounds, such as flavour and aroma components by use of Gas Chromatography-Mass Spectrometry (GC-MS). GC-MS is an analytical method that combines the features of gas-chromatography and mass spectrometry to identify different substances within a test sample.

A sample of a liquid fraction of BSG was compared to a sample of a liquid fraction of BSG extracted with blackcurrant leaves according to example 3 and the difference in the amount of chemical compounds was analysed.

Surprisingly it was found that the sample where the liquid fraction of BSG had been extracted with blackcurrant leaves had a reduced amount of compounds having an unpleasant taste, such as fusel alcohols, diacetyl, acetoin, methylketones, short chained esters such as ethyl formate and ethyl acetate, and ethyl lactate. Chemical compunds that increased in amount in the sample of liquid fraction of BSG extracted with blackcurrant leaves as compared to no extraction with blackcurrant leaves was chemical compounds perceived as having pleasant taste, such as butyl acetate and o-Cymene. Fusel alcohols have an alcoholic, pungent, solvent like taste. Diacetyl and acetoin have an caramel like and buttery taste. Methylketones, such as 2-heptone, has an aroma of blue molded cheese.

The short esters have a flavour of rum, brandy and solvent. Ethyl lactate have a weak fruity, buttery, butterscotch flavour. Butyl-acetate has a fruity apple like taste and aroma.

Hence, extraction with blackcurrant leaves as a surprise would remove unpleasent chemical compounds while the pleasant chemical compounds perceived as good tasting would be increased.

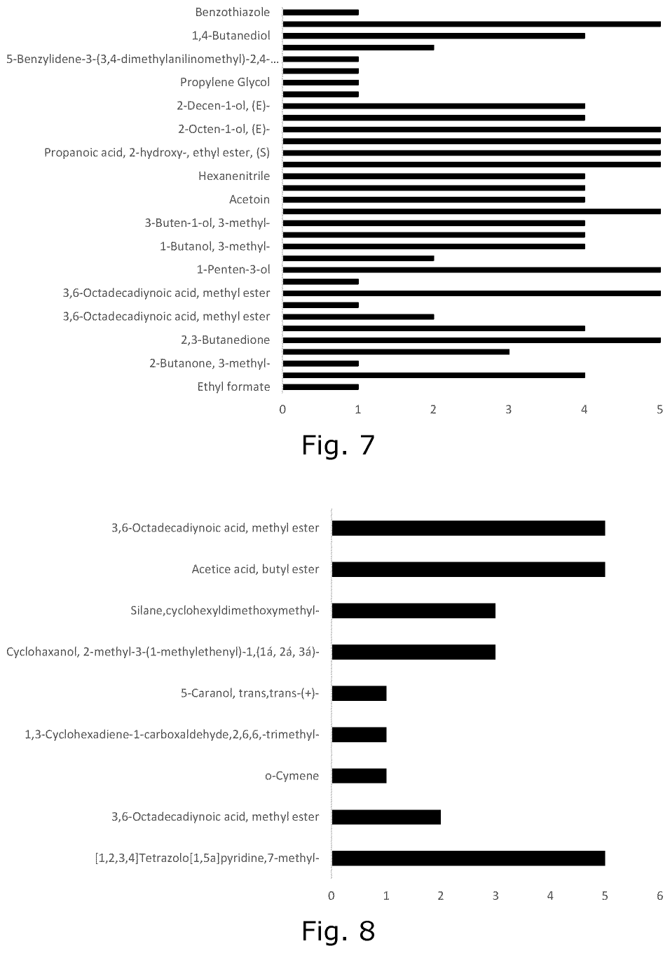

In FIG. 7 is shown some of the chemical compounds that are reduced in amount after a liquid fraction of BSG is extracted with blackcurrant leaves in relation to a liquid fraction not extracted with blackcurrant leaves.

The score 1 in FIG. 7 refers to that 21-25% of the compound is maintained; the score 2 refers to that 16-20% of the compound is maintained; score 3 refers to that 11-15% of the compound is maintained; score 4 refers to that 6-10% of the compound is maintained; score 5 refers to that 0-5% of the compound is maintained.

FIG. 8 shows the chemical compounds that are increased in amount after a liquid fraction of BSG is extracted with blackcurrant leaves in relation to a liquid fraction not extracted with blackcurrant leaves.

The score 1 refers to 2 to 5 times more of the compound; score 2 refers to 6 to 10 times more, score 3 refers to 11-50 times more; score 4 refers to 51 to 100 times more while score 5 refers to more than 100 times of the compound.

### Example 8—Examples of Beverages of the Invention

Example 8 shows different examples of a beverage according to the invention.

TABLE 10
shows an example of a cranberry/lingonberry flavoured beverage

| Ingredients | Amount |
|---|---|
| Cranberry/lingonberry | 192 gram |
| Pear | 500 gram |

Cranberry and lingonberries was chopped and blended in a juicer to prepare a juice. The juice was mixed with a liquid fraction of BSG extracted with blackcurrant leaves in the ratio of 1:3 by weight

TABLE 11
shows an example of a carrot flavoured beverage

| Ingredients | Amount |
|---|---|
| Carrot | 425 gram |
| Sea buckthorn | 19.5 gram |
| Fennel | 130 gram |
| Apple | 162.5 gram |

The above ingredient was mixed and blended to a juice. The juice was mixed with a liquid fraction of BSG extracted with blackcurrant leaves in the ratio of 1:1 by weight

TABLE 12
shows an example of a aronia flavoured beverage

| Ingredients | Amount |
|---|---|
| Aronia | 360 gram |
| Pear | 360 gram |

The above ingredient was mixed and blended to a juice. The juice was mixed with a liquid fraction of BSG extracted with blackcurrant leaves in the ratio of 1:2 by weight

TABLE 13
shows an example of a sea buckthorn flavoured beverage

| Ingredients | Amount |
|---|---|
| Sea buckthorn | 192 gram |
| Pear | 585 gram |

The above ingredient was mixed and blended to a juice. The juice was mixed with a liquid fraction of BSG extracted with blackcurrant leaves in the ratio of 1:3 by weight

TABLE 14
shows an example of a beeroot flavoured beverage

| Ingredients | Amount |
|---|---|
| Beeroot | 315 gram |
| Rosemary | 5 gram |
| Apple | 315 gram |

The above ingredient was mixed and blended to a juice. The juice was mixed with a liquid fraction of BSG extracted with blackcurrant leaves in the ratio of 1:1 by weight

TABLE 15
shows an example of a spinach flavoured beverage

| Ingredients | Amount |
|---|---|
| Spinach | 278 gram |
| Red apple | 208 gram |
| Green apple | 70 gram |
| Basil | 33 gram |
| Cucumber | 140 gram |

The above ingredient was mixed and blended to a juice. The juice was mixed with a liquid fraction of BSG extracted with blackcurrant leaves in the ratio of 3:1 by weight

### Example 9—Preparation of Liquid Breakfast with Liquid Fraction of BSG Water Extracted with Spelt (Dinkel Wheat)

Example 9 shows how to prepare a liquid food product based on a liquid fraction of BSG extracted with spelt, i.e. having a consistence as a type of liquid breakfast. Spelt, also known as dinkel wheat, is a species of wheat.

In a first example: approximately 31 g of spelt is added to 94 ml of a liquid fraction of brewer's spent grain and the mixture is heated to approximately 95-100° C. for about 25-30 minutes to extract the spelt and obtain a mixture of liquid fraction of BSG and spelt. The mixture is cooled to about 5-10° C. and 150 ml of additional liquid fraction of 5 BSG is added to the mixture. The mixture is blended and added 1.9 g cinnamon, 25g dates and 15.6 g sunflower seeds.

In a second example: approximately 50 g of spelt is added to 150 ml of a liquid fraction of brewer's spent grain and the mixture is heated to approximately 95-100° C. for about 25-30 minutes to extract the spelt and obtain a mixture of liquid fraction of BSG and spelt. The mixture is cooled to about 5-10° C. and 50 ml of ground toasted hazelnut (shells removed—is approx. 25 g), 250 ml of additional liquid fraction of BSG is added together with 40 g dates and 2.5 g cinnamon before blending.

### Example 10—Preparation of Chocolate Drink with Liquid Fraction of BSG Water Extracted with Cocoa

Cocoa, sugar and salt was added to 2 decilitre of liquid fraction of brewer's spent grain in amounts of cocoa (2 g), salt (0.1 g) and sugar (2 g). The mixtures were heated approximately 98° C. for about 6 minutes. The boiled liquid fraction with ingredients is then sieved. For comparing, samples were also made of a beverage with liquid fraction of brewer's spent grains without adding ingredients. Sensory evaluation was made with a test panel of 5 panelist scoring the taste of the samples from 1 to 10, where 10 is the best. The result is shown in table 16 below:

TABLE 16

| Sample | Score |
|---|---|
| Liquid fraction of BSG boiled with cocoa, sugar and salt | 8 |
| Liquid fraction of BSG boiled, but with no ingredients | 3 |
| added | |
| Liquid fraction of BSG, unboiled and with no | 1 |
| ingredients added | |

### Example 11—Preparation of Vanilla Drink with Liquid Fraction of BSG Water

Vanilla, sugar and salt was added to 2 decilitre of liquid fraction of brewer's spent grain in amounts of vanilla (4.5 g), salt (0.2 g) and sugar (1 g). The mixture was heated approximately 98° C. for about 6 minutes. For comparing, samples were also made of a beverage with liquid fraction of brewer's spent grains without adding ingredients. Sensory evaluation was made with a test panel of 5 panelist scoring the taste of the samples from 1 to 10, where 10 is the best. The result is shown in table 17 below:

TABLE 17

| Sample | Score |
|---|---|
| Liquid fraction of BSG boiled with vanilla, salt and sugar | 7.8 |
| Liquid fraction of BSG boiled, but with no vanilla added | 3 |
| Liquid fraction of BSG, unboiled, and with no vanilla | 1 |
| added | |

### Example 12—Preparation of Peppermint, Licorice, and Lemongrass Drink with Liquid Fraction of BSG Water

A tea bag based on peppermint, licorice and lemongrass (2 g) was added to 2 decilitre of liquid fraction of brewer's spent grain. The mixtures were heated to approximately 98° C. for about 6 minutes. For comparing, samples were also made of a beverage with liquid fraction of brewer's spent grains without adding ingredients. Sensory evaluation was made with a test panel of 5 panelist scoring the taste of the samples from 1 to 10, where 10 is the best. The result is shown in table 18 below:

TABLE 18

| Sample | Score |
|---|---|
| Liquid fraction of BSG boiled with teabag of | 6.8 |
| peppermint, licorice, and lemongrass | |
| Liquid fraction of BSG, boiled but without teabag | 3 |
| Liquid fraction of BSG, unboiled and without teabag | 1 |

### Example 13—Preparation of Sweat Choco and Chili Drink with Liquid Fraction of BSG Water

A tea bag based on sweat choco and chili (2 g) was added to 2 decilitre of liquid fraction of brewer's spent grain. The mixtures were heated to approximately 98° C. for about 6 minutes. For comparing, samples were also made of a beverage with liquid fraction of brewer's spent grains without adding ingredients. Sensory evaluation was made with a test panel of 5 panelist scoring the taste of the samples from 1 to 10, where 10 is the best. The result is shown in table 19 below:

TABLE 19

| Sample | Score |
|---|---|
| Liquid fraction of BSG boiled with teabag with sweat | 4.6 |
| choco and chili | |
| Liquid fraction of BSG, boiled but without teabag | 3 |
| Liquid fraction of BSG, unboiled and without teabag | 1 |

### Example 14—Preparation of Green Chai with Liquid Fraction of BSG Water

A tea bag based containing green chai (2 g) was added to 2 decilitre of liquid fraction of brewer's spent grain. The mixtures were heated to approximately 98° C. for about 6 minutes. For comparing, samples were also made of a beverage with liquid fraction of brewer's spent grains without adding ingredients. Sensory evaluation was made with a test panel of 5 panelist scoring the taste of the samples from 1 to 10, where 10 is the best. The result is shown in table 20 below:

TABLE 20

| Sample | Score |
|---|---|
| Liquid fraction of BSG boiled with teabag with green | 5.6 |
| chai | |
| Liquid fraction of BSG, boiled but without teabag | 3 |
| Liquid fraction of BSG, unboiled and without teabag | 1 |

1-22. (canceled)

23. A liquid food product comprising a liquid fraction of a brewers spent grain in an amount in the range of from 10% to 100% by weight, wherein the liquid fraction of brewer's spent grain is the liquid obtained after mechanical separation of raw brewer's spent grain into a solid fraction and liquid fraction.

24. The liquid food product according to claim 23, wherein the liquid fraction of brewer's spent grain does not comprise any added enzymes.

25. The liquid food product according to claim 23, wherein the liquid fraction of brewer's spent grain comprises dietary fibres in an amount of 2% by weight or less.

26. The liquid food product according to claim 23, wherein the liquid food product is selected from the group of a beverage, a liquid breakfast, a porridge, a dessert, a sauce, and a soup.

27. The liquid food product according to claim 23, wherein the liquid product furthermore comprises one or more flavour improving agent(s).

28. The liquid food product according to claim 27, wherein the flavour improving agent(s) is one or more selected from the group of an extract of an ingredient of vegetable material or animal material, a fruit or vegetable juice, a sweetener, a flavouring agent, and a spice.

29. The liquid food product according to claim 28, wherein the flavour improving agent(s) at least comprises one or more selected from the group of an extract of an ingredient of vegetable material or animal material.

30. The liquid food product according to claim 29, wherein the flavour improving agent is an extract of an ingredient of vegetable material, wherein the vegetable material is one or more selected from the group of plant leaves, flower buds, nuts, cereals, grains, seeds, needles from trees, peel from fruit, algae, mushrooms, seaweed, roots.

31. The liquid food product according to claim 29, wherein the flavour improving agent is an extract of an ingredient of animal material, wherein the animal material is one or more selected from the group of meat broth, bone broth, animal guts or animal bowels.

32. The liquid food product according to claim 23, wherein the liquid food product does not comprise raw brewer's spent grain or diluted raw brewer's spent grain.

33. The liquid food product according to claim 23, wherein said liquid fraction of brewer's spent grain comprises a dry matter content of 20% by weight or less.

34. A method of preparing a liquid food product comprising the steps of:
i) providing a liquid fraction of brewer's spent grain, wherein the liquid fraction of brewer's spent grain is the liquid obtained after mechanical separation of raw brewer's spent grain into a solid fraction and liquid fraction;
ii) optionally adding further ingredients;
iii) subject the liquid fraction of brewer's spent grain to a step of inactivating unwanted microorganism; and
hereby obtain the liquid food product.

35. The method according to claim 34, wherein one or more flavour improving agent(s) is/are added to the liquid fraction of brewer's spent grain before or after inactivating unwanted microorganisms in step ii).

36. The method according to claim 34, wherein the flavour improving agent(s) is/are one or more selected from the group of an extract of an ingredient of vegetable material or animal material, fruit juice, vegetable juice, sweetener, syrup, flavouring agent, and spices.

37. The method of preparing a liquid food product according to claim 35, comprising the steps of:
i) providing a liquid fraction of a brewer's spent grain, wherein the liquid fraction of brewer's spent grain is the liquid obtained after mechanical separation of raw brewer's spent grain into a solid fraction and liquid fraction;
adding one or more flavour improving agent(s) selected from the group of an ingredient of vegetable material or animal material to the fraction of brewer's spent grain to provide a mixture and perform an extraction of the mixture;
ii) optionally adding one or more further ingredients;
iii) subject the extracted mixture of step i) or ii) to a step of inactivating unwanted microorganism in the mixture; and
hereby obtain the liquid food product.

38. The method according to claim 37, wherein the mechanical separation is selected from the group of a screw press, a filter press, a centrifuge or membrane filtration.

39. The method according to claim 37, wherein the flavour improving agent is an extract of an extract of one or more ingredient of vegetable material, wherein the vegetable material is fresh vegetable material, dried or frozen vegetable material.

40. The method according to claim 37, wherein the flavour improving agent is an extract of an ingredient of vegetable material, wherein the vegetable material is one or more selected from the group of plant leaves, flower buds, nuts, cereals, grains, seeds, needles from trees, peel from fruit, algae, mushrooms, seaweed, and roots.

41. The method according to claim 37, wherein the extraction in step i) is by heating the mixture to a temperature in the range of from 72° C. to 120° C. for 2 to 60 minutes.

42. The method according to claim 37, wherein the extraction in step i) is by cooling the mixture of step to a temperature of 10° C. or below allow to extract for 10 to 48 hours.
